(19) United States
(12) Patent Application Publication
(10) Pub. No.: US 2015/0317667 A1
(43) Pub. Date: Nov. 5, 2015

(54) SYSTEM AND METHOD FOR PROVIDING DYNAMIC PRICING USING IN-STORE WIRELESS COMMUNICATION

(71) Applicants: AT&T Intellectual Property I, L.P., Atlanta, GA (US); AT&T Mobility II LLC, Atlanta, GA (US)

(72) Inventors: Randolph Wohlert, Austin, TX (US); Joseph Mendoza, Austin, TX (US); James H. Pratt, Round Rock, TX (US)

(73) Assignees: AT&T Intellectual Property I, L.P., Atlanta, GA (US); AT&T Mobility II LLC, Atlanta, GA (US)

(21) Appl. No.: 14/267,542

(22) Filed: May 1, 2014

(51) Int. Cl. G06Q 30/02

(52) U.S. Cl. CPC G06Q 30/0235

(57) ABSTRACT

Methods and apparatuses for providing a notification of a discount price for an item are disclosed. For example, a method includes detecting a presence of a mobile device at a store, and sending the notification via a wireless communication to the mobile device, the notification comprising an identification of the item, the discount price for the item, an expiration date for the item and information associated with a location of the item within the store, wherein the discount price for the item is based upon the expiration date of the item.

The present disclosure relates generally to methods and apparatuses for providing and receiving a notification of a discount price for an item, e.g., by providing dynamic pricing to in-store consumers via wireless communications.

### BACKGROUND

Many products, especially food products, have a variety of product “expiry” dates posted on them. More than one term is commonly used to provide expiry information, including “Use By”, “Sell By”, and “Best Used By”. Although it may not be clear how long after expiry of a product is still safe, it is commonly understood that you should buy a product before the date expires. After a product's expiry date is past, the product may be extremely difficult to sell, and the value may essentially become zero. In practice, the value of the product may become negative in that it then costs the merchant to remove and dispose of the product. In addition, the magnitude of food wastage due to products going unsold and unused due to expiration dates being exceeded before purchase or use is significant. The merchant may resort to various discounts for products which are approaching an expiration date in order to avoid a total loss of sale. However, typically the merchant may manually adjust the price, e.g., by placing a half-price sticker on the item or updating a display price on a shelf.

### SUMMARY

Embodiments of the present disclosure disclose methods and apparatuses for providing and receiving a notification of a discount price for an item. For example, in one embodiment a method includes detecting a presence of a mobile device at a store, and sending the notification via a wireless communication to the mobile device, the notification comprising an identification of the item, the discount price for the item, an expiration date for the item and information associated with a location of the item within the store, wherein the discount price for the item is based upon the expiration date of the item.

In another embodiment, an apparatus includes a processor and a computer-readable medium storing instructions which, when executed, cause a processor to perform operations that include detecting a presence of a mobile device at a store, and sending the notification via a wireless communication to the mobile device, the notification comprising an identification of the item, the discount price for the item, an expiration date for the item and information associated with a location of the item within the store, wherein the discount price for the item is based upon the expiration date of the item.

In still another embodiment, a method includes notifying, by a processor of a mobile device, an application server associated with a store of a presence of the mobile device, receiving, by the processor, the notification comprising an identification of the item, the discount price for the item, an expiration date for the item and information associated with a location of the item within the store, and presenting, by the processor on a display of the mobile device, the identification of the item, the discount price for the item, the expiration date for the item and the information associated with the location of the item within the store.

### BRIEF DESCRIPTION OF THE DRAWINGS

The teachings of the present disclosure can be readily understood by considering the following detailed description in conjunction with the accompanying drawings, in which:

FIG. 1 illustrates an exemplary system related to the present disclosure;

FIGS. 2A-2C illustrate an exemplary store environment and system for providing a notification of a discount price for an item, according to the present disclosure;

FIG. 3 illustrates a flowchart of a method for providing a notification of a discount price for an item according to the present disclosure;

FIG. 4 illustrates a flowchart of a method for receiving a notification of a discount price for an item according to the present disclosure; and

FIG. 5 illustrates a high-level block diagram of a general-purpose computer suitable for use in performing the functions, methods, operations and algorithms described herein.

To facilitate understanding, identical reference numerals have been used, where possible, to designate identical elements that are common to the figures.

### DETAILED DESCRIPTION

Many products have expiration dates that impact a merchant's ability to sell these products (e.g., perishable products) as the expiration dates approach, e.g., baked goods, refrigerated goods such as eggs, dairy products, seafood and the like. One embodiment of the present disclosure features a communication system that leverages the use of wireless communication, e.g., Bluetooth Low Energy (BLE), to communicate dynamic pricings to a consumer. For example, when a consumer enters a store (broadly a commercial establishment where goods or products are sold), such as a supermarket, an application server associated with the store and having information pertaining to the dynamic pricing of various products may communicate such pricing information dynamically to a mobile device of the customer. The communication may be transmitted wirelessly via one or more communication points, e.g., BLE communication points, situated throughout the supermarket. For example, the merchant may deploy one communication point at the bakery, one communication point at the meat department, one communication point at the seafood department, one communication point for each aisle in the supermarket, and so on. In one embodiment, the application server may reside within a local network of the merchant or in a cloud-based network location associated with the merchant. In another embodiment, the application server is situated at a telecommunication service provider's network. Embodiments of the present disclosure are applicable not only to food products with an expiry date, but to other items as well, for example, seasonal clearance items, sales for excess inventory, etc.

In one example, the dynamic pricings of the present disclosure are associated with the expiration date of the products. For example, in one embodiment the system sends a message (broadly a notification) to a consumer that indicates the discounted price and/or the amount of the discount, and the “reason” for such pricing, e.g., “ABC brand of bread is available for $.50/loaf with expiration date of today only”, or “ABC brand of cereal is available for $1.00/box with expiration date of one week from today”, and the like. This is in contrast to general discounts which provide no information related to the expiration date of the offered goods and which may in fact have no relation to the expiration date.

In one example, the dynamic pricing is based upon historical data, taking into consideration a variety of factors. For instance, in one embodiment, the system may track the price as a function of expiry time and a sales rate. The probability of selling an item at a given price with a given amount of time left before expiry may then be determined. An example for a hypothetical item X is given in Table 1 below:

TABLE 1

| | Time before Expiry | | | | | | |
|---|---|---|---|---|---|---|---|
| | 96 | 48 | 24 | 12 | 6 | 1 | |
| | hrs | hrs | hrs | hrs | hrs | hr | 0 |
| Recommended Price | $2.50 | $2.00 | $1.75 | $1.50 | $1.00 | $.75 | $.50 |
| Sales Probability | 78% | 67% | 50% | 43% | 75% | 25% | 2% |

Notably, the calculated optimal price point for a given item at various times is not necessarily static. Instead, the price points may fluctuate for a variety of reasons, including changes in the wholesale cost of the product, seasonal variation, and so forth. For example, producers of products may collect and supply historical data regarding sales rates to merchants along with their products. The historical sales rates may include sales rates observed at various times prior to an expiration date and at various offered prices. In addition, merchants may share or resell their data, based on actual product sales, to others. For example, sales data may be provided by a merchant to a producer of a product or to a data aggregator (e.g., a telecommunication network provider or other third party) which may amass sales data for various products across multiple enterprises and on a regional basis. As such, dynamic pricing of a product can vary on a regional basis, e.g., by county, state, locality, etc.

In another example, the optimal price of an item at a given time may change based upon more “local” data. For instance, the system may implement an algorithm-based approach to determine a merchant's current level of inventory of an item, and accounting for the expiration date(s) of the items in stock, the system may adjust the current price and forecast optimal prices at a number of future times. For seasonal sales items, the merchant could establish an “expiry” date that reflects the date by which the product needs to be sold. For instance, the value of a seasonal item at expiry may not be zero, and a minimum price could be identified. If the item does not sell at that price, then it could be returned or stored, e.g., until next season. An illustrative algorithm for calculating a current discounted price is given as follows:

ChangePrice (ItemID)

| | |
|---|---|
| IF | NumberOfItems (ItemID) > MinimumNumItems (ItemID) ; |
| | have items ? |
| AND | TimeTilExpiry (ItemID) > MinimumExpiryTime (ItemID) ; not |
| | expired? |
| AND | NumberItemsSold (ItemID, TimeInterval (ItemID)) < |
| | ItemMinThreshold (ItemID) ; not selling? |
| THEN | PriceDelta := AdjustPrice (ItemID) ; determine % to change |
| | price ; the AdjustPrice function considers time to expiry, |
| | current price, etc. |
| | ; the AdjustPrice function can set a minimum price |
| | CurrentPrice (ItemID) = BasePrice (ItemID) x PriceDelta |

The advantage of this algorithm-based approach is that it does not require extensive historical data to implement, and can provide a starting point for a product for which the merchant does not have data, such as new products, etc. As an item's expiry date approaches, the price is automatically adjusted.

In still another example, the system may use a hybrid approach combing aspects of historical data supplied from one or more sources with “local” data regarding inventory and expiration date(s) to determine the dynamic pricing of various item being sold by a merchant. For example, the system may maintain a set of recommended price points for an item at various times prior to the expiration date, where the system may deviate from the recommended price points depending upon the inventory level of the store, and a current sales trend, e.g., based upon a number of sales in a recent time period and the like.

In one example, the present disclosure includes an augmented reality feature where a customer's mobile device may be directed at a product and the customer's mobile device may capture product identifying information such as image data, barcode information, quick response (QR) code information, RFID tag information, BLE tag information and so forth. The mobile device may upload this information to the application server for analysis, e.g., via BLE through one or more communication points in the store. For example, the application server may match the product identifying information to a specific product, determine a price for the item, which may comprise a discount price based upon an approaching expiration date, and convey information pertaining to the price (e.g., an original price, a discounted price, a reason for the discount, such as the approaching expiration date, and so forth) back to the mobile device, e.g., via BLE from one or more communication points in the store. The user's mobile device may then overlay the product price on the image presented on the device's screen/display. The price can be visually emphasized in a variety of ways (e.g., highlighted, animated, presented in a three-dimensional representation, etc.).

Additionally, in one embodiment the mobile device may present a larger view of one or more potentially attractive price reduced items. For example, a user could stand at the head of an aisle in a supermarket, and view the aisle through the mobile device's display. Items that may be of interest, with dynamically reduced prices for example, may then be indicated, e.g., via an overlay on the view of the aisle being presented on the screen. For example, the price may be presented in a highlighted manner, e.g., animated, “floating” in space near the product, etc. The product itself could be highlighted. In one example, the information may be color-coded to reflect the amount of the price reduction. In addition, in one example other information could be provided in addition to the price information (e.g., health related information, etc.). In one example, the information is provided audibly as well visually (e.g., a verbal description of product value, promotion, status, features, etc.).

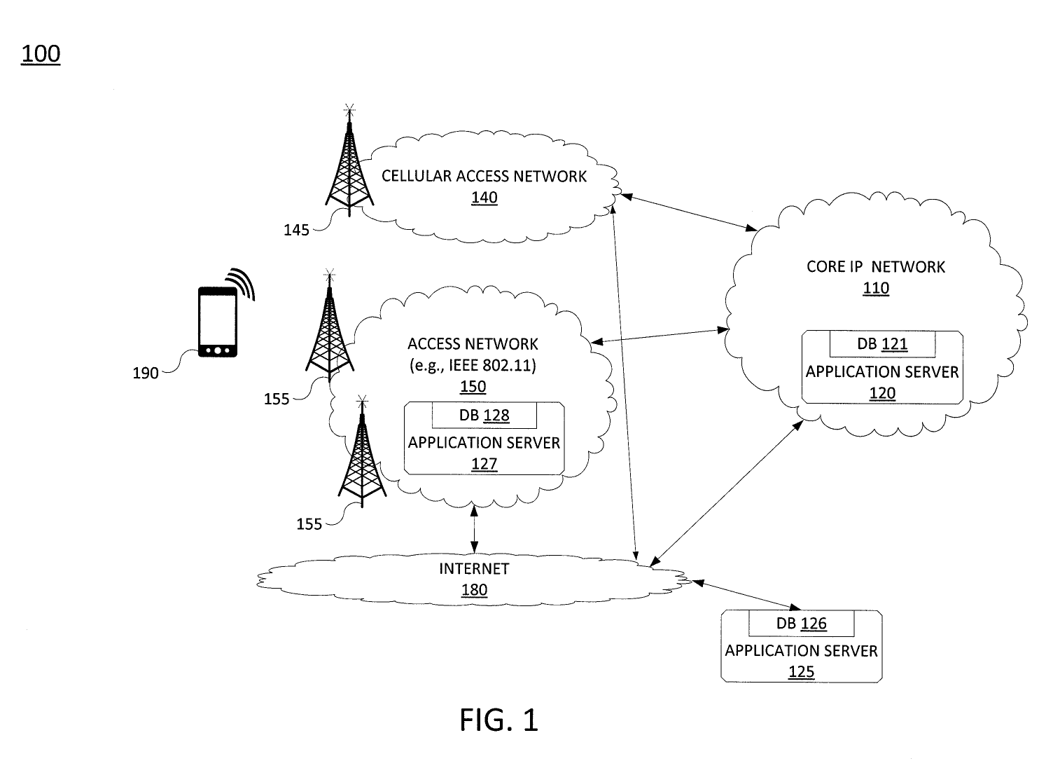

The above disclosure highlights various features and advantages of embodiments of the present disclosure for providing a notification of a discount price for an item. To better understand the present disclosure, FIG. 1 illustrates in greater detail an exemplary system 100 for providing and/or receiving a discount price for an item, according to the present disclosure. Although the present disclosure is discussed below in the context of a particular system or network architecture, the present disclosure is not so limited. Namely, the present disclosure can be applied to any type of communication network that is capable of transmitting data, such as a local area network (LAN), a wireless local area network (WLAN), an Internet Protocol (IP) network, such as an Internet Protocol/Multi-Protocol Label Switching (IP/MPLS) core network, an IP Multimedia Subsystem (IMS) network, communications over the Internet in general, and so forth.

As shown in FIG. 1, the system 100 connects a mobile device 190 with one or more application servers via a core network, e.g., an Internet Protocol (IP) network 110, a cellular access network 140, a wireless or wired access network 150 and/or Internet 180. In one embodiment, cellular access network 140 may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, cellular access network 140 may comprise an access network in accordance with any “second generation” (2G), “third generation” (3G), “fourth generation” (4G), Long Term Evolution (LTE) or any other yet to be developed future wireless/cellular network technology. While the present disclosure is not limited to any particular type of wireless access network, in the illustrative embodiment, cellular access network 140 is shown as a UMTS terrestrial radio access network (UTRAN) subsystem. Thus, element 145 may comprise a Node B or evolved Node B (eNodeB).

In one embodiment, access network 150 may comprise a non-cellular access network such as a wireless local area network (WLAN), an IEEE 802.11 network, a “wired” access network, e.g., a local area network (LAN), an enterprise network, a metropolitan area network (MAN), a digital subscriber line (DSL) network, a cable network, a hybrid network utilizing a plurality of such technologies, and so forth. Thus, in one example access network 150 may include at least one wireless communication point 155, which may comprise a wireless access point/wireless router, an IEEE 802.11 access point, a ZigBee access point, a Bluetooth Low Energy (BLE) beacon, scanner and/or access point, a radio frequency identification (RFID) tag reader, or scanner, and so forth. In one example, access network 150 may include multiple wireless communication points 155 of different types. As just one example, the access network 150 may include at least one BLE beacon and at least one RFID reader. In addition, in one example access network 150 is owned and/or operated by a merchant. In other words, access network 150 may comprise a local business network, an enterprise network or the like which is at least partially deployed at a location of a merchant, e.g., in a supermarket.

In one embodiment core IP network 110 comprises a telecommunication network service provider network with network devices or elements (not shown) which are capable of routing and forwarding IP packets between different hosts over the network. However, in one embodiment, the components of core IP network 110 may have additional functions, e.g., for functioning as a public land mobile network (PLMN)-General Packet Radio Service (GPRS) core network, for providing Voice over Internet Protocol (VoIP), Service over Internet Protocol (SoIP), and so forth, and/or may utilize various different technologies, e.g., Asynchronous Transfer Mode (ATM), Frame Relay, multi-protocol label switching (MPLS), and so forth. Thus, it should be noted that although core IP network 110 is described as an Internet Protocol network, this does not imply that the functions are limited to IP functions, or that the functions are limited to any particular network layer.

In one embodiment, mobile device 190 may comprise any endpoint device configured for wireless communication such as a personal computer, a laptop computer, a Wi-Fi device, a Personal Digital Assistant (PDA), a mobile phone, a smartphone, an email device, a computing tablet, a messaging device, and the like. In one embodiment, mobile device 190 may have both cellular and non-cellular access capabilities and may further have wired communication/networking capabilities. In addition, in accordance with the present disclosure, the mobile device 190 may run a shopping experience application, or “local application”, which enables the mobile device 190 to interact with an application server (AS) (e.g., any one or more of AS 120, AS 125 and AS 127) for receiving a notification of a discount price for an item. In one example, the local application also provides the mobile device 190 with the ability to, inter alia: communicate an electronic shopping list to the application server, provide location information of the mobile device 190 to the application server and/or receive location information of the mobile device 190 from the application server, receive location information of one or more discounted items from the application server, display a store map, and provide an augmented reality display on the mobile device 190 for assisting the customer (i.e., the user of the mobile device) in locating a discounted item. In one embodiment, the customer logs-in via the local application on the mobile device 190 which allows the customer/mobile device 190 to interact with the application server.

In one embodiment, the telecommunication network service provider may maintain an application server (AS) 120 in the core IP network 110 for providing a notification of a discount price for one or more items according to an expiration date to the customer/mobile device 190, e.g., via the local shopping experience application operating on the mobile device 190. Alternatively, the network service provider (e.g., the owner and/or operator of core IP network 110) may maintain application server (AS) 120 on behalf of the merchant, or on behalf of a plurality of different merchants. For example, AS 120 may collect pricing and purchasing data from producers of products, from retailers/merchants based upon actual sales of such products to aggregate and to provide discount pricing data across multiple merchants on a local basis (e.g., by town or county), on a regional basis, and the like. In this regard, the application server 120 may also include a database (DB) 121 for storing such information. In one embodiment, the DB 121 stores further information for providing the discount price for one or more items according to an expiration date, as will be described in greater detail below. In one embodiment, AS 120 may comprise any hardware server or computer that is well known in the art, and the database 121 may be any type of electronic collection of data that is also well known in the art.

In one example, the information for providing the discount price for one or more items according to an expiration date comprises, for each item, an identification of the item, a discount price for the item, an expiration date for the item and/or information associated with a location of the item within the store. In one example, the identification information of an item may include a name of the item, barcode, BLE tag information and/or RFID tag identification information of the item, a stock keeping unit (SKU) number and/or product number, and so forth. In one example, the location of the item within the store is determined by BLE tag/beacon tracking, RFID tag/reader tracking, or other tracking method. For example, if the merchant prefers to implement item tracking using BLE, then each item may be affixed with or otherwise associated with a BLE tag, and wireless communication point 155 may be implemented as a BLE beacon, scanner or access point. On the other hand, if the merchant prefers to utilize RFID tracking, then each item may be associated with an RFID tag, and wireless communication point 155 may comprise an RFID reader.

However, in this example, the access network 150 may further require at least one additional wireless communication point 155 for interacting with mobile device 190, e.g., a wireless router, wireless access point, BLE beacon, etc. In other words, at least a first wireless communication point 155 may be used for RFID item tracking while at least a second wireless communication point 155 may be used for communicating with mobile device 190.

In still another example, a near-field communication (NFC) capability can be used to establish the physical proximity of the customer's mobile device 190 and a product, then BLE can be used to provide the current product price for the product to the mobile device 190. This approach leverages a synergy between the two radio technologies (NFC and BLE).

In still another embodiment, a merchant may maintain its own application server, e.g., AS 127, for providing a discount price for one or more items according to an expiration date. Thus, in one embodiment, AS 127 may comprise any hardware server or computer that is well known in the art, and the database 128 may be any type of electronic collection of data that is also well known in the art. Accordingly, AS 127 may provide the same or substantially similar functions as AS 120, as described herein.

In still another embodiment an application server, e.g., AS 125, may be maintained “in the cloud”, i.e., reachable via the Internet 180 in general. In one example, AS 125 is maintained by the merchant, or is maintained by another entity and performs operations controlled by the merchant or by the other entity, e.g., a cloud service provider. In another example, AS 125 is controlled and/or operated by an entity other than the merchant, such as a producer of a food product that is sold by the merchant. Thus, in one example the producer of the food product may receive at AS 125 sales data for its product from different merchants, where the sales data may indicate a sales price, an amount of time left until the expiration date at a time when a sale was made, a location of a sale, and so forth. From this information, the producer of the product may calculate recommended price points for the product at various times (e.g., at different points in time prior to an expiration date) and at various locations (e.g., a first set of recommended price points in one region of the country and a second set of recommended price points in another region with different market factors). In one embodiment, AS 125 may comprise any hardware server or computer that is well known in the art, and the database 126 may be any type of electronic collection of data that is also well known in the art. Accordingly, AS 125 may provide the same or substantially similar functions as AS 120, as described herein.

In one example, AS 120 and/or AS 125 may perform various functions relating to providing a notification of a discount price for one or more items according to an expiration date. However, in one example, AS 120 and/or AS 125 may further interact with AS 127 to provide such functions. For instance, AS 125 may calculate recommended price points for an item based upon data that is received from the merchant via AS 127, and/or from other merchants. AS 125 may then communicate the recommended price points to AS 127. As such, AS 127 may offer to a customer using endpoint device 190 a discount price for the item at a particular time based upon the recommended price points received from the other AS 125. In this regard, it should be noted that any one or more of AS 120, 125 and/or 127 may calculate discount prices for one or more items based upon approaching expiration dates using aspects of historical data supplied from one or more sources, “local” data regarding inventory and expiration date(s), or a hybrid approach combining both aspects to determine the dynamic pricing of various item being sold by a merchant. Other, further and different variations of the same or a similar nature are all contemplated within the scope of the present disclosure

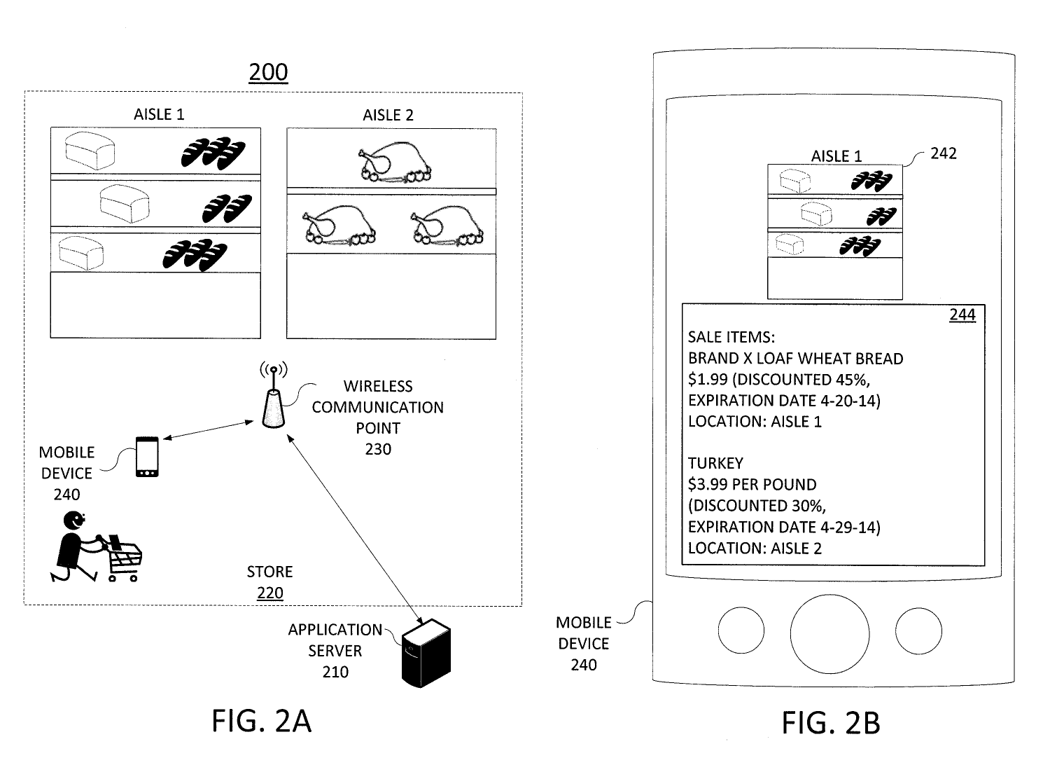

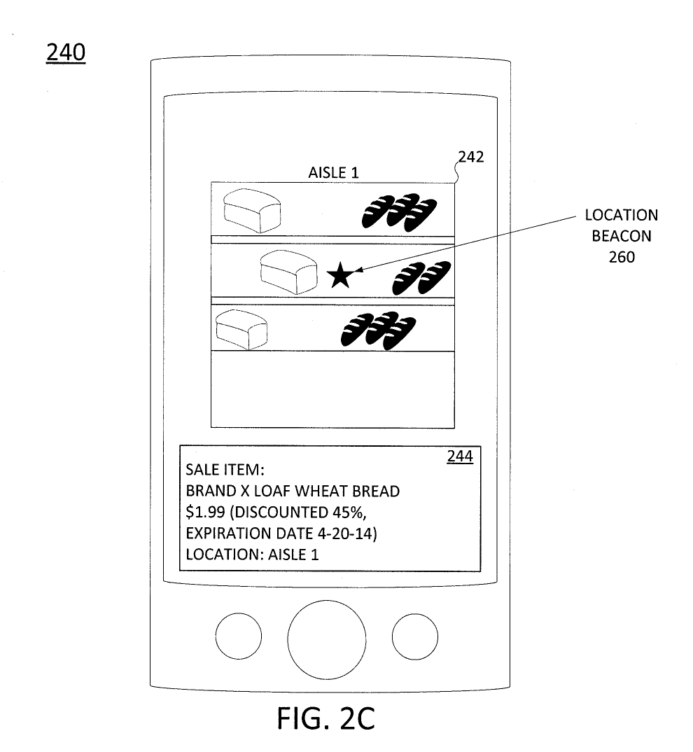

FIG. 2A illustrates an exemplary store environment and system 200 where a customer with a mobile device 240 is shopping in a store 220, e.g., a supermarket. When the customer enters the store, the mobile device 240 automatically registers with the application server (AS) 210 associated with the store. For instance, the mobile device 240 may register with server 210 via communication point 230 which enables the mobile device 240 to then receive communications from server 210, e.g., a notification of a discount price for one or more items based upon an approaching expiration date. For instance, a customer may download the local application to his or her mobile device 240 in any one of several methods, such as via an online application store or a variety of Internet sites, from a retail store where the mobile device is purchased, or in the merchant's store itself. For example, the mobile device 240 may be provided with a copy of the application from application server 210 or other store based servers, or cloud-based servers associated with the merchant via WLAN, BLE or an in-store docking station, via a cellular network, and so forth.

For mobile device 240 (having the local application installed and running thereon), the customer may enter a username and/or password or otherwise activate a shopping experience application on mobile device 240 prior to or after entering the store 220. The application may then attempt to communicate with application server 210 via wireless communication point 230. In one example, the mobile device 240 may send the communication using short-range wireless communication such as Bluetooth, BLE, ZigBee and the like, depending upon the nature of wireless communication point 230. In this regard, it should be noted that, the wireless communication point 230 may be the same or substantially similar to one or more of the wireless communication points 155 in FIG. 1, e.g., a BLE beacon, a WLAN access point, etc.

Although the present example is described in connection with communications between mobile device 240 and AS 210 via wireless communication point 230, the present disclosure is not so limited. For example, the application server 210 may reside within a local network of the store 220, which further includes wireless communication point 230. However, AS 210 may also reside in a telecommunication network service provider network, or may be located “in the cloud”. As such, in one example, communications between mobile device 240 and AS 210 may involve only a local network of the store 220. However, in another example, communications may alternatively or additionally traverse a core IP network, a cellular network, the Internet in general, and so forth. Thus, AS 210 may be the same or substantially similar to any one of application servers 120, 125 or 127 of FIG. 1, and may be located in any number of locations and in any number of different networks. Henceforth, for illustrative purposes it is assumed that communications between AS 210 and mobile device 240 traverse wireless communication point 230.

Accordingly, when the mobile device 240 is sufficiently nearby to the wireless communication point 230 such that wireless communication point 230 is capable of receiving wireless communications from mobile device 240, then mobile device 240 may register with application server 210 via the wireless communication. In one example, the wireless communication from mobile device 240 may identify the mobile device and/or the customer and may include information sufficient to identify that the communication is intended for the application server 210/store 220. In one example, the registration of the customer and/or mobile device 240 may also be facilitated by user image recognition, e.g., via an in-store camera, a cellular communication, and so forth.

After the mobile device 240 is registered, the application server 210 may communicate a notification of a discount price for one or more items according to an expiration date to mobile device 240 via wireless communication point 230. The communication from application server 210 may, but need not comprise a same communication type as that used to announce the presence of mobile device 240 to the application server 210. For example, the mobile device and application server 210 may communicate with one another using BLE via wireless communication point 230. However, the mobile device 240 may also register with application server 210 via a cellular network (not shown) but receive communications from application server 210 via BLE, or other short-range communication.

The communication from application server 210 may include an identification of the item, a discount price for the item, an expiration date for the item and/or information associated with a current location of the item within the store. In one example, the communication may also include a map of the store. In this regard, the application server 210 may track the location of the mobile device throughout the store 220 using any one or more location tracking techniques. For example, the mobile device 240 may measure received signal strengths from multiple wireless communication points in the store 220 (including wireless communication point 230) and report such information back to application server 210 via wireless communication point 230. In turn, application server 210 may determine the location of mobile device 240 within the store based upon such information. In another example, the application server 210 may cross-reference received signal strengths of communications from the mobile device 240 as reported by a number of wireless communication points with known fixed locations throughout the store. Based upon such information, the application server 210 may then calculate the location of the mobile device 240.

In one example, the application server 210 may send additional communications to the mobile device 240 to guide the mobile device 240 to an item for which a discount is being offered. For example, the mobile device 240 may receive a communication from application server 210 that includes an identification of the item, a discount price for the item, an expiration date for the item and information associated with a location of the item within the store. The mobile device 240 may then display such information, e.g., as shown in FIG. 2B on the portion of the display 244 of mobile device 240. In this example, a loaf of Brand X wheat bread is on sale for $1.99, the price is discounted 45 percent based on an expiration date of Apr. 20, 2014 and the item is located in Aisle 1. The user may indicate an interest in purchasing the discounted loaf of bread, e.g., by clicking tapping on the information for the item. The shopping experience application may then cause mobile device 240 to send a further communication to application server 210 containing this indication.

In response, the application server 210 may communicate a map of the store with an indicator of the current location of the mobile device 240 along with a location of the item (in this case, the loaf of bread). As the customer moves throughout the store 220 and the location of mobile device 240 changes, the mobile device 240 may continue to provide signal strength information to application server 210 and application server 210 may transmit current location information to be presented on the map of the store displayed by the mobile device 240.

In still another example, the shopping experience application may include an augmented reality aspect to assist the customer in navigating the store 240 and locating one or more items for which a discount based upon an expiration date is being offered. For example, the application may cause mobile device 240 to capture a current view of the store 220 from a camera of the mobile device and to present the current view on a screen of the mobile device. For instance, as shown in FIG. 2B, mobile device 240 is capturing and presenting a view of Aisle 1 in a portion of the display/screen . The shopping experience application running on mobile device 240 may then cause the mobile device 240 to overlay a marker, image or other indicator of a location and/or identification of a discounted item. For instance, FIG. 2C illustrates a location beacon 260 for the item (e.g., the bread loaf) overlayed on the image of Aisle 1 that is captured and presented by the mobile device 240 in the portion of the display 242.

In one example, the item may be tagged or affixed with a BLE tag, a RFID tag or similar device which can be detected by one or more wireless communication points, such as wireless communication point 230, and the detection reported to application server 210. Thus, application server 210 may determine the current location of one or more items via a BLE beacon/scanner, RFID tag reader, etc., and provide such location information to the mobile device 240. This enables the mobile device 240 to provide an augmented reality experience, such as illustrated in FIG. 2C, or to indicate the location of the item on a map of the store 220, as in the earlier example.

In another embodiment, the application server 210 may provide sufficient information to the mobile device 240 to enable the mobile device 240 to independently detect the location of the item. For example, the item may be affixed with a specific BLE tag or RFID tag having a universally unique identify (UUID) which is broadcasted and/or is transmitted upon the tag being read. The application server 210 may store this information in a database and provide the tag identifying information to mobile device 240 either in an initial wireless communication to the mobile device 240 or in a subsequent communication, e.g., after the customer has indicated a further interest in a specific discounted item that has been offered. The mobile device 240 may then detect the specific item of interest if it read the BLE tag and/or RFID tag information that matches the information provided by the application server 210. Having detected the item and its location, the mobile device 240 may then place the location beacon 260 on the portion of the display 242 as an indicator of the detected location of the item. Notably, the actual location of the item that is determined in this way by the application server 210 and/or the mobile device 210 may be more detailed and accurate, e.g., as opposed to initial location information provided by application server 210 which may simply indicate “Aisle 1”. This is particularly useful where there may be numerous other items of the same type nearby which are not being offered with the same discount. In other words, the customer is enabled to find a specific item from among a number of similar items based upon the beacon/tag information.

Although several examples are described herein for tracking the locations of a mobile device and one or more items in a store, and for displaying such location information on a mobile device, the present disclosure is not limited to these particular techniques. For example, global positioning system (GPS) location tracking, base station cellular signal tracking, and the like, may be utilized as alternatives to, or in conjunction with the techniques described above.

In one example, one or more items having discount prices based upon their expiration dates may be offered in a personalized fashion to the customer via mobile device 240. For example, the customer may share a shopping list with application server 210. Alternatively, or in addition, application server 210 may store historical data representing the past purchases of the customer. In this way, although there may be many items for which the merchant is offering discount prices based upon approaching expiration dates, the application server 210 may select only a small number to offer to the subscriber based upon the items being the same or similar to items on the shopping list and/or in the customer's purchasing history. Similarly, in one example, the mobile device 240 may receive information regarding a number of products, where the local application allows the customer to search for offers in different product categories, search by keywords, such as product names and brand names, and so forth.

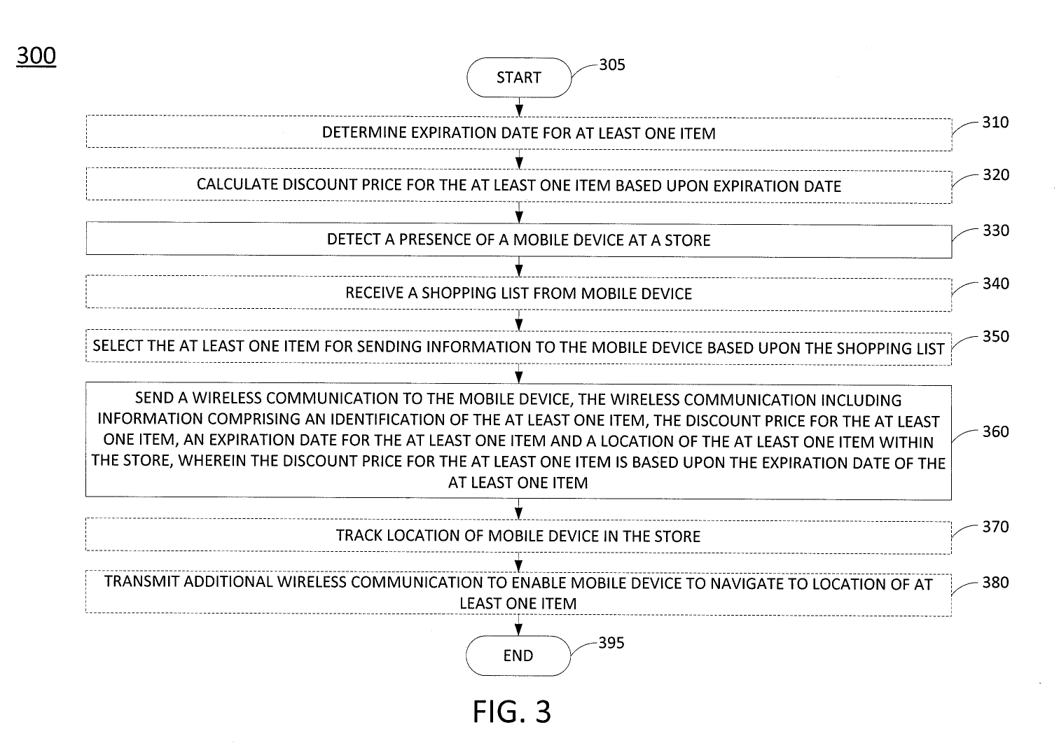

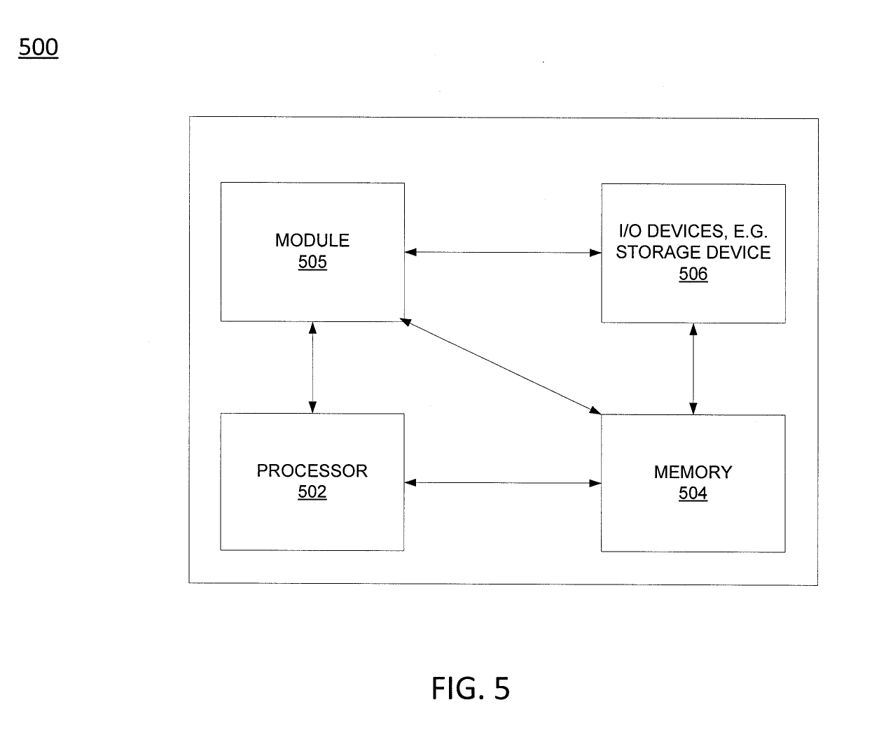

To further illustrate examples of the present disclose, FIG. 3 depicts a flowchart of a method 300 for providing a discount price for an item. In one embodiment the steps, operations or functions of the method 300 may be performed by any one or more of the components of the system 100 depicted in FIG. 1. For example, in one embodiment, the method 300 is performed by one or more of the application servers 120, 125 or 127 in FIG. 1. Alternatively, or in addition, one or more steps, operations or functions of the method 300 may be implemented by a general purpose computer having a processor, a memory and input/output devices as illustrated in FIG. 5 and discussed below, specifically programmed to perform the steps, functions and/or operations of the method. For illustrative purposes, the method 300 will now be described in terms of an embodiment where operations of the method are performed at an application server, such as application server 127 in FIG. 1.

The method 300 begins in step 305 and proceeds to optional step 310. At optional step 310, the method 300 determines an expiration date for at least one item. For example, as described above an application server may include a database that stores product information on various items for sale in a store. In one example, the product information may include a product name, a SKU number, a barcode, QR code, RFID tag or BLE tag identifier, a location of the item within the store, an expiration date of the item, and so forth.

At optional step 320, the method 300 calculates a discount price for the at least one item based upon the expiration date. For example, as described above price points may be determined as a function of an item's expiry time and a sales probability at a given price point. In one example, the sales probability is based upon historical sales rates observed at various times prior to a product's expiration and at various offered prices. In one example, historic data includes data not just from the merchant's store, but may be aggregated over a plurality of stores, e.g., in a geographic area or region. In another example, the method implements an algorithm-based approach that accounts for “local” data such as a current level of inventory of the same the item in the store and the various expiration dates of the stock of inventory. In still another example, the discount pricing decision implements a hybrid approach that accounts for historic data as well as the available “local” data.

It should be noted that the method 300 may calculate discount prices for multiple items for sale in the store and may revise the calculations at various times, e.g., once per day, once per week, one week prior to expiration, three days prior to expiration, on the day of expiration, etc. The method may implement different schedules for price revisions/price discounting for different items. For instance, cereal products may be scheduled for price discounts one week prior to expiration, while fresh bread products may be scheduled for a single price discount on the day of the product expiration. Alternatively, or in addition, the merchant may allow some products to have continuously calculated price discounts based upon approaching expiration dates. For example, as each customer walks into a store at successively later times, the method may recalculate a discount price. Thus, it is possible that each customer will be quoted a different discounted price depending upon the actual time in which the customer arrives at the store.

At step 330, the method 300 detects a presence of a mobile device as the store. For example, the mobile device may send a wireless communication identifying the mobile device and/or the customer, e.g., via WLAN, Bluetooth, BLE and so forth. For instance, if the mobile device is within the store or is sufficiently proximate to the store, the communication from the mobile device may be received by one or more wireless communication points deployed within the store and forwarded to an application server. In one example, the mobile device transmits login credentials to enable the identification of the particular customer and/or mobile device and to allow the store to commence two-way communication with the mobile device.

At optional step 340, the method 300 receives a shopping list from the mobile device. For example, the mobile device may transmit an electronic shopping list, e.g., along with a wireless communication that is received at step 330 or in a separate communication. For example, the customer may transmit the shopping list via the mobile device, from the customer's home computer, or in another fashion at some time prior to the customer's actual visit to the store. Accordingly, the method may store the shopping list for later use. For instance, upon detection of the presence of the customer and/or mobile device at step 330, the method 300 may include retrieving the previously stored shopping list for the customer.

At optional step 350, the method 300 selects at least one item for offering a discount price to the customer, taking into account the items on the shopping list. For example, if there are a large number of items for which discounts based upon approaching expiration dates are being offered by the store, the method 300 may select only one or a handful of such items to be presented to the customer. The items which are selected from the larger pool of potential items to offer may be matched to items on the shopping list. For example, there may be an exact product match, or the item may fit within a general description of a desired item on the shopping list, e.g., any loaf of bread being discounted may match if the shopping list entry simply mentions “bread loaf”, as opposed to something more specific such as “Brand X whole wheat bread loaf”. Similarly, even if the customer has included a specific item in his or her shopping list, the method may nevertheless select a discounted item to present to the mobile device if it is similar to the specific item. For instance, the customer may be persuaded to buy Brand Y whole wheat bread for 50 percent off, even if the user typically prefers Brand X.

At step 360, the method 300 sends a wireless communication to the mobile device, where the wireless communication includes information comprising an identification of the item, the discount price for the item, an expiration date for the item and information associated with a location of the item within the store. In one example, the discount price for the item is based upon the expiration date of the item. For example, the method 300 may select one or more items at step 350 above for presentation to the customer's mobile device. Alternatively, or in addition, the method 300 may select at least one item for presentation based upon historical data regarding the shopping habits of the customer. For instance, if the customer typically purchases organic products, the method may prioritize offers for discounted organic products with approaching expiration dates.

In one example, the method 300 may include additional information in the wireless communication at step 360. For example, the method may include a map of the store along with indications of the locations of one or more of the items in the store. The mobile device may then present the map as well as a marker of the location on a screen of the mobile device. Alternatively, or in addition, the method 300 may include RFID tag information, BLE tag information or the like that is associated with the item to enable the mobile device to independently detect the location of an item in the store, e.g., if the mobile device is equipped with a RFID tag reader or a BLE scanning/advertising capability. In still another example, the mobile device may provide an augmented reality experience to the customer, e.g., by presenting on a display of the mobile device an image of the store captured from a camera of the mobile device, and overlaying a location indicator/marker of the item on the image.

At optional step 370, the method 300 tracks a location of the mobile device within the store. Notably, in some cases the store-based infrastructure and the capabilities of the mobile device may enable the customer to independently navigate to the at least one item, e.g., using RFID tracking, BLE, NFC or other short-range tracking technology. However, in the event the mobile device is not so equipped, in one example, the method 300 may determine the location of the mobile device by tracking WLAN, Bluetooth, BLE or other communication/signal types transmitted by the mobile device and received by one or more communication points situated throughout the store. For example, the distance between the mobile device and a particular communication point may be inferred based upon a received signal strength, or in a similar manner.

At optional step 380, the method 300 transmits one or more additional wireless communications to enable the mobile device to navigate to a location of the at least one item via. For example, the method 300 may track the location of the mobile device at optional step 370 and may send updated location information of the mobile device to the mobile device. Thus, where the mobile device is presenting a map of the store on the mobile device's screen, the mobile device may display a current location of the mobile device on the map. Following any of steps 360-380, the method 300 proceeds to step 395 where the method ends.

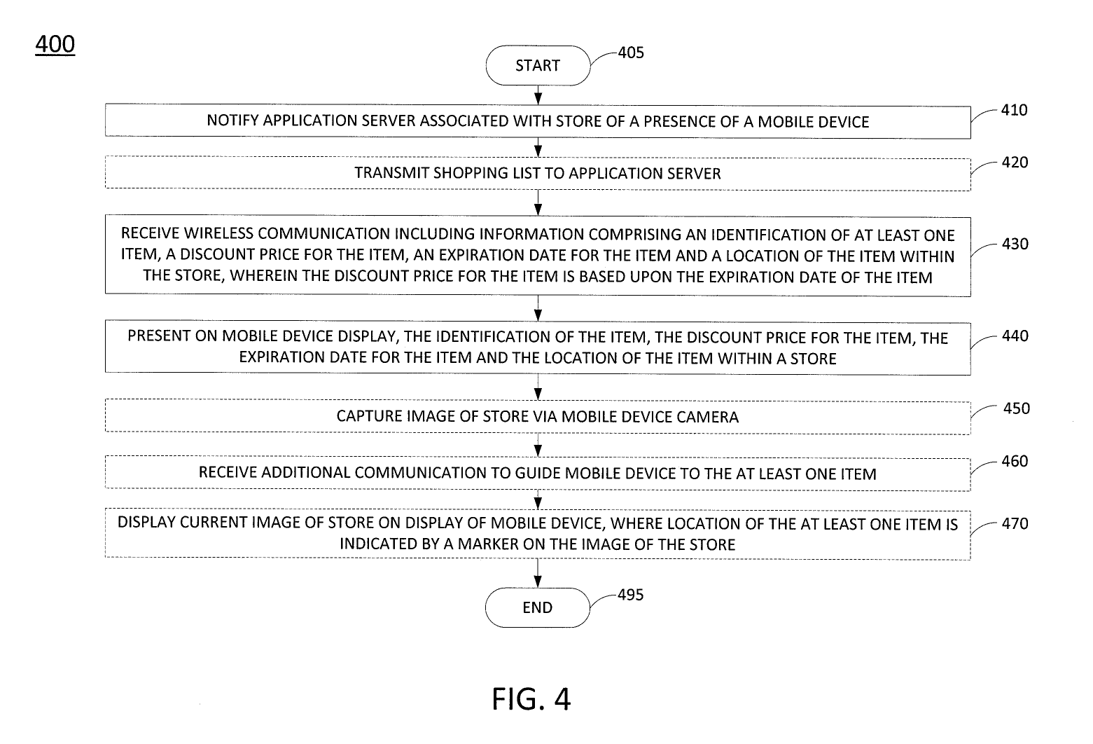

FIG. 4 illustrates a flowchart of a method 400 for receiving a discount price for an item. In one embodiment, the steps, operations or functions of the method 400 may be performed by the mobile device 190 of FIG. 1 or by the mobile device 240 of FIGS. 2A-2C. Alternatively, one or more steps, operations or functions of the method 400 may be implemented by a general purpose computer having a processor, a memory and input/output devices as illustrated in FIG. 5 and described below, specifically programmed to perform the steps, functions and/or operations of the method. For illustrative purposes, the method 400 will now be described in terms of an embodiment where operations of the method are performed at a mobile device.

The method 400 begins in step 405 and proceeds to step 410. In step 410, the method 400 notifies an application server associated with a store of a presence of the mobile device. For example, the method may send a wireless communication via the mobile device identifying the mobile device and/or the customer using the mobile device. For instance, if the mobile device is within the store or is sufficiently proximate to the store, the communication may comprise a WLAN, Bluetooth or BLE communication, or the like, and may be received by one or more wireless communication points deployed within the store and forwarded to an application server. In one example, the method transmits login credentials to enable the identification of the particular customer and/or mobile device by the application server.

At optional step 420, the method 400 transmits a shopping list to the application server. For example, the shopping list may be conveyed as part of the same wireless communication sent at step 410 or in a separate communication, e.g., after the application server confirms registration of the mobile device. In any case, the application server may select one or more items for which a discount prices are being offered based upon approaching expiration dates for presentation to the customer.

At step 430, the method 400 receives a wireless communication that include information comprising an identification of the item, the discount price for the item, an expiration date for the item and information associated with a location of the item within the store. In one example, the discount price for the item is based upon the expiration date of the item. In addition, the application server may select the item for presentation to the customer's mobile device based upon the customer's shopping list.

Alternatively, or in addition, the application may select the item for presentation based upon historical data regarding the shopping habits of the customer. In one example, the wireless communication that is received at step 430 further includes an image of the store comprising a map of the store. In one example, the information associated with a location of an item within the store comprises general information such as that the at least one item is located in “Aisle 1”, in the “bakery”, in the “frozen foods” section, and so forth. In another example, the information associated with the location of the item comprises more specific and accurate location information such as a current position of the item as detected by one or more RFID tag readers, BLE beacons/scanners and so forth. In this regard, the location information may further indicate the current position with reference to a map of the store. In still another example, the wireless communication received at step 430 may further include RFID tag information, BLE tag information or the like that is associated with the item to enable the method to independently detect the location of an item in the store, e.g., in the event the mobile device is equipped with a RFID tag reader or a BLE antenna for BLE scanning/advertising capability.

At step 440, the method 400 presents on a display of the mobile device the identification of the item, the discount price for the item, the expiration date for the item and the location of the item within the store.

At optional step 450, the method 400 captures an image of the store via a camera of the mobile device. Notably, the method 400 may capture a current image of the store on a continuous basis as the customer moves the mobile device throughout the store and as a field of view of the camera changes.

At optional step 460, the method 400 receives one or more additional communications to guide the mobile device to the location of the at least one item. For example, the application server may calculate a location of the mobile device within the store in various ways such as tracking WLAN, Bluetooth, BLE or other communication/signal types transmitted by the mobile device and received by one or more communication points situated throughout the store. In addition, the application server may send one or more wireless communications via one or more of the wireless communication points to the mobile device to inform the mobile device of the mobile device's current location.

At optional step 470, the method 400 displays an image of the store on a display of the mobile device. In one example, the image of the store comprises a map of the store. In another example, the image of the store comprises a current view of the store captured via a camera of the mobile device. In one embodiment, the method may further present a visual indication of the location of the at least one item on the image of the store. For example, the location of the at least one item may be indicated with a marker overlayed on a map or on a current view of the store captured from the mobile device's camera. In addition, in the case where the method 400 displays a map of the store, the method may further indicate a current location of the mobile device within the store by an additional marker overlayed on the map. For example, the method may receive a wireless communications at step 460 updating the current location of the mobile device as determined by the application server.

However, in another example the store-based infrastructure and the capabilities of the mobile device may enable the method 400 to independently navigate the mobile device to the at least one item, e.g., using RFID tracking or BLE tracking. For example, the method 400 may determine the location of the mobile device and/or the location of the at least one item within the store using such techniques. As such, the method may then display the location(s) of the mobile device and/or the at least one item overlayed on an image of the store. Following any of steps 440-470, the method 400 proceeds to step 495 where the method ends.

In addition, although not specifically specified, one or more steps, functions or operations of the respective methods 300 and 400 may include a storing, displaying and/or outputting step as required for a particular application. In other words, any data, records, fields, and/or intermediate results discussed in the methods can be stored, displayed and/or outputted either on the device executing the methods 300 or 400, or to another device, as required for a particular application.

Furthermore, steps, blocks, functions or operations in FIGS. 3 and 4 that recite a determining operation or involve a decision do not necessarily require that both branches of the determining operation be practiced. In other words, one of the branches of the determining operation can be deemed as an optional step. Furthermore, steps, blocks, functions or operations of the above described methods can be combined, separated, and/or performed in a different order from that described above, without departing from the example embodiments of the present disclosure.

FIG. 5 depicts a high level block diagram of a general purpose computer or system suitable for use in performing the functions described herein. For example, any one or more components or devices illustrated in FIG. 1 and FIGS. 2A-2C, or described in connection with the methods 300 and 400 may be implemented as the system 500. As depicted in FIG. 5, the system 500 comprises a hardware processor element 502 (e.g., a microprocessor, a central processing unit (CPU) and the like), a memory 504, (e.g., random access memory (RAM), read only memory (ROM) a disk drive, an optical drive, a magnetic drive, and/or a Universal Serial Bus (USB) drive), a module 505 for providing or receiving a notification of a discount price for an item, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that embodiments of the present disclosure can be implemented in software and/or in a combination of software and hardware, e.g., using application specific integrated circuits (ASIC), a general purpose computer or any other hardware equivalents, e.g., computer readable instructions pertaining to the methods discussed above can be used to configure a hardware processor to perform the steps, functions and/or operations of the above disclosed methods. In one embodiment, the present module or process 505 for providing or receiving a notification of a discount price for an item can be implemented as computer-executable instructions (e.g., a software program comprising computer-executable instructions) and loaded into memory 604 and executed by hardware processor 502 to implement the functions as discussed above in connection with the exemplary methods 300 and 400 respectively. As such, the present module or process 505 providing or receiving a notification of a discount price for an item as discussed above in respective methods 300 and/or 400 (including associated data structures) can be stored on a non-transitory (e.g., tangible or physical) computer readable storage medium or device, e.g., RAM memory, magnetic or optical drive or diskette and the like.

It should be noted that the hardware processor can be configured or programmed to cause other devices to perform one or more operations as discussed above. In other words, the hardware processor may serve the function of a central controller directing other devices to perform the one or more operations as discussed above.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a notification of a discount price for an item, comprising:
detecting, by a processor, a presence of a mobile device at a store; and
sending, by the processor, the notification via a wireless communication to the mobile device, the notification comprising an identification of the item, the discount price for the item, an expiration date for the item and information associated with a location of the item within the store, wherein the discount price for the item is based upon the expiration date of the item.

2. The method of claim 1, further comprising:
determining the expiration date of the item; and
calculating the discount price for the item based upon the expiration date.

3. The method of claim 1, further comprising:
receiving a shopping list from the mobile device; and
selecting the item for sending the notification based upon the shopping list.

4. The method of claim 1, wherein the wireless communication is sent from a wireless communication point located within a local network of the store.

5. The method of claim 1, wherein the notification is sent to the mobile device when the presence of the mobile device at the store is detected.

6. The method of claim 1, wherein a receipt of the notification causes the mobile device to present an image of the store on a display of the mobile device, wherein the location of the item within the store is indicated by a marker on the image of the store.

7. The method of claim 6, wherein the image of the store comprises a map of the store.

8. The method of claim 6, wherein the image of the store comprises a current image of the store captured by a camera of the mobile device.

9. The method of claim 1, further comprising:
tracking a location of the mobile device within the store; and
transmitting an additional wireless communication to the mobile device, the additional wireless communication including information that identifies the location of the mobile device.

10. The method of claim 1, wherein the location of the mobile device within the store is determined via a wireless communication point.

11. The method of claim 1, wherein the location of the item within the store is determined via a radio frequency identification tag associated with the item.

12. The method of claim 1, wherein the location of the item within the store is determined via a wireless communication point.

13. An apparatus for providing a notification of a discount price for an item, comprising:
a processor; and
a computer-readable medium storing instructions which, when executed by the processor, cause the processor to perform operations, the operations comprising:
detecting, by a processor, a presence of a mobile device at a store; and
sending, by the processor, the notification via a wireless communication to the mobile device, the notification comprising an identification of the item, the discount price for the item, an expiration date for the item and information associated with a location of the item within the store, wherein the discount price for the item is based upon the expiration date of the item.

14. A method for receiving a notification of a discount price for an item, comprising:
notifying, by a processor of a mobile device, an application server associated with a store of a presence of the mobile device;
receiving, by the processor, the notification comprising an identification of the item, the discount price for the item, an expiration date for the item and information associated with a location of the item within the store; and
presenting, by the processor on a display of the mobile device, the identification of the item, the discount price for the item, the expiration date for the item and the information associated with the location of the item within the store.

15. The method of claim 14, wherein the notification is received from a wireless communication point located within a local network of the store.

16. The method of claim 14, wherein the presenting the location of the item within the store comprises presenting an image of the store on a display of the mobile device, wherein the location of the item within the store is indicated by a marker on the image of the store.

17. The method of claim 16, wherein the image of the store comprises a map of the store.

18. The method of claim 16, wherein the image of the store is received from a wireless communication point located within a local network of the store.

19. The method of claim 14, further comprising:
capturing a current image of the store via a camera of the mobile device; and displaying the current image of the store on the display of the mobile device, wherein the location of the item within the store is indicated by a marker on the image of the store.

20. The method of claim 14, further comprising:
determining the location of the item within the store using the information associated with the location of the item within the store, wherein the information associated with the location of the item within the store comprises radio frequency identification tag identifying information.
